(19) United States
(12) Patent Application Publication
(10) Pub. No.: US 2018/0277806 A1
(43) Pub. Date: Sep. 27, 2018

(54) BATTERY COMPARTMENT AND ELECTRONIC CIGARETTE HAVING SAME

(71) Applicant: SHENZHEN IVPS TECHNOLOGY CO., LTD., Shenzhen (CN)

(72) Inventor: Wen CHEN, Shenzhen (CN)

(73) Assignee: SHENZHEN IVPS TECHNOLOGY CO., LTD., Shenzhen (CN)

(21) Appl. No.: 15/935,764

(22) Filed: Mar. 26, 2018

(30) Foreign Application Priority Data
Mar. 27, 2017 (CN) 201720313340.9

(51) Int. Cl. H01M 2/10; A24F 47/00

(52) U.S. Cl. CPC H01M 2/1055; H01M 2220/30; A24F 47/008

(57) ABSTRACT

A battery compartment includes a bracket, a main body mounted to the bracket, a cover rotatably mounted to the bracket, and an elastic pushing rod mounted on the bracket. The cover defines a blocking groove. The pushing rod is configured for inserting into the blocking groove to elastically support the cover when the cover is rotated.

### CROSS REFERENCE TO RELATED APPLICATIONS

The present application claims the priority of Chinese Patent Application No. 201720313340.9 filed on Mar. 27, 2017, the content of which is hereby incorporated by reference.

### TECHNICAL FIELD

The present disclosure relates to electronic cigarettes, in particular to a battery compartment and an electronic cigarette having the battery compartment.

### BACK GROUND

Electronic cigarettes are also known as virtual cigarettes, or E-atomizers. The electronic cigarette is a heat-not-burn product and provided with efficacies similar to those of the ordinary cigarette. For example, the electronic cigarette can refresh the smokers and satisfy their smoking addiction, making them happy and relaxed. Typically, the battery compartment has a main body and a cover. The cover is rotatably connected to the main body via a pivot. The cover defines an oblong through hole to enable the pivot to rotate therein, and the cover is thus opened and closed. However, the cover will wobble easily while the cover is opened. Furthermore, the cover will impact the main body and the lacquer on the surface of cover will be badly chipped when the cover rotated by an undesirable (too large) angle.

Therefore, there is room for improvement in the art.

### SUMMARY

The present disclosure relates to a battery compartment and an electronic cigarette having the battery compartment. The battery compartment includes a bracket, a main body mounted to the bracket, a cover rotatably mounted to the bracket, and an elastic pushing rod mounted on the bracket. The cover defines a blocking groove. The pushing rod is configured to extend to the blocking groove to elastically support the cover when the cover is rotated.

### BRIEF DESCRIPTION OF THE DRAWINGS

For a better understanding of the embodiments of the present disclosure or the technical scheme in the prior art, accompanying drawings needed in the description of the embodiments or the prior art are simply illustrated below. Obviously, the accompanying drawings described below are some embodiments of the present disclosure. For the ordinary skill in the field, other accompanying drawings may be obtained according to the structure shown in these accompanying drawings without creative work.

FIG. 1 is an exploded perspective view of a battery compartment accordance with an embodiment.

FIG. 2 is a cross-sectional view of the battery compartment with a cover closed in accordance with an embodiment.

FIG. 3 is a cross-sectional view of the battery compartment with the cover opened in accordance with an embodiment.

FIG. 4 is an isometric view of the cover shown in FIG. 1 in accordance with an embodiment.

### DETAILED DESCRIPTION OF THE EMBODIMENTS

A clear and complete description as below is provided for the technical scheme in the embodiments of the present disclosure in conjunction with the drawings in the embodiments of the present disclosure. Obviously, the embodiments described hereinafter are simply part embodiments of the present disclosure, but all the embodiments. All other embodiments obtained by the ordinary skill in the art based on the embodiments in the present disclosure without creative work are intended to be included in the scope of protection of the present disclosure.

It should be noted that all directional indications (such as top, bottom, left, right, front, behind . . . ) in the embodiments of the present disclosure are merely to illustrate a relative position relation, a relative motion condition, etc. between each part in a certain state (for example, the state shown in the drawings). If the state changes, the directional indication changes accordingly.

In addition, if terms “first”, “second”, etc. appear in the present disclosure, they are merely for the purpose of description, but cannot be understood as the indication or implication of relative importance or as the implicit indication of the number of the designated technical features; therefore, features defined by “first” and “second” may specifically or implicitly include one or more such features. In the description of the present disclosure, unless otherwise stated, “a plurality of” means at least two, for example, two, three, etc.

In the present disclosure, unless otherwise specifically stated and defined, terms “connected”, “fixed”, etc. should be interpreted expansively. For example, “fixed” may be fixed connection, also may be detachable connection, or integration; may be mechanical connection, also may be electrical connection; may be direct connection, also may be indirect connection through an intermediate, and may be internal communication between two elements or interaction of two elements, unless otherwise specifically defined. The ordinary skill in this field can understand the specific implication of the above terms in the present disclosure according to specific conditions.

In addition, technical schemes of each embodiment of the present disclosure maybe combined mutually; however, this must be carried out on the basis that the or ordinary skill in this field can implement the combination. When the combination of technical schemes has a conflict or cannot be implemented, it should considered that such combination of technical schemes does not exist and is not in the scope of protection claimed by the present disclosure.

The present disclosure relates to a battery compartment for an electronic cigarette, aiming to solve the problem of wobble in structure in related art.

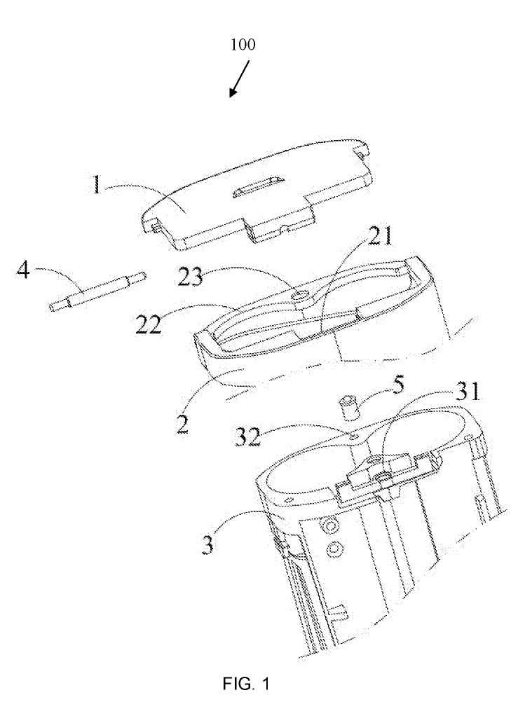

Referring to FIGS. 1-4, in one exemplary embodiment, a battery compartment 100 includes a bracket 3, a main body 2 mounted on the bracket 3, a cover 1 having a blocking groove 12 rotatably mounted to the main body 2 via a pivot 4, and an elastic pushing rod 5 assembled to the bracket 3. When the cover 1 is rotated, the pushing rod 5 extends into the blocking groove 12 to elastically resist against the cover 1. It is also understood that, the pushing rod 5 contacts to a position of the cover 1 corresponding to the blocking groove 12 to exert an elastic force to resist against the cover 1.

As illustrated in FIG. 1, the bracket 3 defines a receiving hole 31, and a first threaded hole 23. The bracket 3 is made of plastic materials.

The pushing rod 5 is received in the receiving hole 31 and fixed to the bracket 3. The pushing rod 5 is an elastic element made of rubber material. In some embodiments, the pushing rod 5 can also be an extend-retract structure which includes a sleeve (not labeled), and a rod (not labeled) and a spring (not labeled) received in the sleeve. The spring is limited between the rod and the sleeve. The spring enables the rod to extend or retract with respect to the sleeve.

As illustrated in FIG. 1, the main body 2 defines a second threaded hole 23. The main body 2 is fixed on the bracket 3 via a screw being engaged with the first threaded hole 31 and the second threaded hole 23. The main body 2 further defines a concaved portion 21, the concaved portion 21 defines two opposites pivot holes (not labeled). The main body 2 further includes a stepping suture 22 accommodated with the cover 1. So that, an outer surface of the cover 1 away from the main body 2 and an outer surface of the main body 2 away from the bracket 3 are on a same plane when the cover 1 is closed.

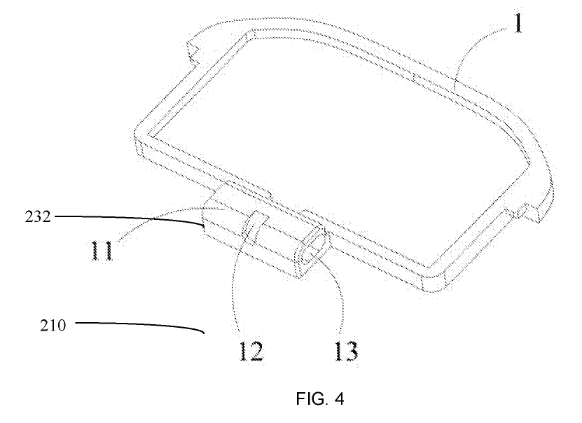

As illustrated in FIG. 4, the cover 1 includes a protrusion portion 11 extending from an end of the cover 1. The protrusion portion 11 defines a through hole 13 running through two opposite ends of the protrusion portion 11. The pivot 4 is inserted into and rotated in the through hole 13 to enable the cover 1 to rotate with respect to the main body 2. The through hole 13 is an oblong through hole. The blocking groove 12 is defined on the protrusion portion 11. Accurately, the blocking groove 12 is concaved from an inner surface of the cover 1 facing the main body 2, thus, the cover 1 forms a bottom side (not labeled) and a sidewall (not labeled) extending from an end of the bottom side on the cover 1. The side wall is far away from the end of the cover 1 extending the protrusion portion 11.

As illustrated in FIG. 1, the pivot 4 includes a main portion (not labeled) and two opposite ends(not labeled) located at opposite ends of the main portion. A length of the main portion is the same with that of the through hole 13 along a center axis of the through hole. A diameter of the limiting portion is smaller than that of the pivot holes. The main portion is located in the through hole 13 of the cover 1, the two opposite ends oppositely extend out of the through hole 13 to inserted into the pivot holes of the main body 2. Thus, the pivot 4 enables the cover 1 to rotatably mount to the main body 2.

When assembled, first, the pivot 4 is inserted into the through hole 13 of the cover 1. In detail, the main portion is located in the through hole 13, and the two opposite ends extend out of the protrusion portion via the through hole 13. Second, the cover 1 is assembled to the main body 10. In detail, the cover 40 together with the pivot 30 are positioned above the main body 10 that the protrusion is in alignment with the concaved portion 21, and then the cover 1 is gradually moved to the main body 10 to make the protrusion portion 11 gradually insert into the concaved portion 21 and the opposite ends are pressed to deform. When the two opposite ends move to the pivot holes, the opposite ends are correspondingly extended into the pivot holes to mount the cover 1 to the main body 2. Third, the pushing rod 5 is placed into the receiving hole 31 and fixed in the bracket 3. Fourth, the main body 2 is fixed on the bracket 3. In detail, a screw is engaged with the first threaded hole 23 of the main body 2 and the second threaded hole 32, thus the main body 2 and the bracket 3 are firmly interconnected. Thus, the assembly of the case 100 is finished.

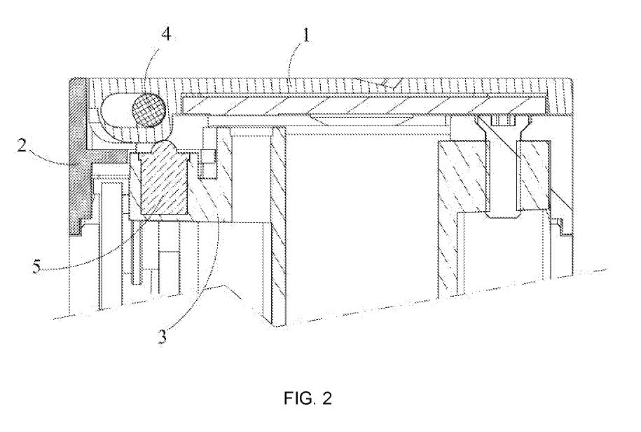

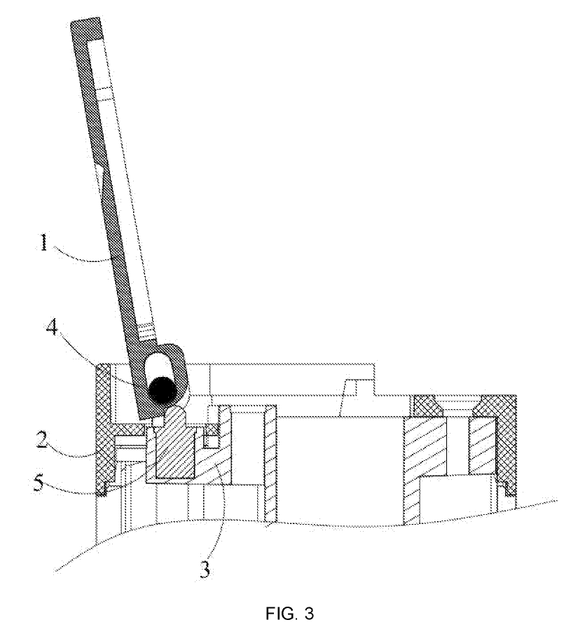

As illustrated in FIG. 3, when the cover 1 is rotated to open, the pushing rod 5 is supported on the bottom side corresponding to the blocking groove 12, and the cover 1 is thus prevented from swaying under the action of an elastic force provided by the pushing rod 5. As illustrated in FIG. 2, when the cover 1 is sufficiently opened, the pushing rod 5 resistances against a sidewall of the cover 1, and the cover 1 is thus prevented from rotating to impact the main body 2, and lacquer on the surface of cover 5 will avoid badly chipping.

Simultaneously, when the cover 1 is closed, the pushing rod 5 supports on the cover 1, the cover 1 will avoid dropping off from the main body 2. Furthermore, the elastic force is exerted to the cover 1 to resist against the cover 1 when the covered is opened, so that the cover 1 will be not opened while the cover 1 is gently pushed by chance.

The present disclosure also provides an electronic cigarette (not shown). The electronic cigarette includes the battery compartment 100 described above and an atomizer coupled to the battery compartment described above. Accordingly, the electronic cigarette can be retained stabilization.

The above are preferred embodiments of the present disclosure merely and are not intended to limit the patent scope of the present disclosure. Any equivalent structures made according to the description and the accompanying drawings of the present disclosure without departing from the idea of the present disclosure, or any equivalent structures applied in other relevant technical fields directly or indirectly are intended to be included in the patent protection scope of the present disclosure.

What is claimed is:

1. A battery compartment, comprising:
a bracket;
a main body mounted to the bracket;
a cover rotatably mounted to the main body, the cover defining a blocking groove; and
an elastic pushing rod mounted on the bracket, the pushing rod being configured for inserting into the blocking groove to elastically support the cover when the cover is rotated.

2. The battery compartment according to claim 1, wherein an end of the cover extends to form a protrusion portion, the blocking groove is defined on the protrusion portion, the main body defines a concaved portion, and the protrusion portion is accommodated in the concaved portion.

3. The battery compartment according to claim 2, further comprising a pivot, wherein the pivot enables the cover to rotatably mount to the main body, the pivot comprising two opposite ends, the pivot is rotatably inserted into the protrusion portion, the two opposite ends oppositely extend out of the protrusion portion and insert into the main body.

4. The battery compartment according to claim 2, wherein the pivot further comprises a main portion rotatably received in the protrusion portion, the two opposite ends extend from the main portion, a length of the main portion is larger than that of the through hole along an axis of the through hole.

5. The battery compartment according to claim 2, wherein the protrusion portion further defines a through hole, the through hole is an oblong hole and the pivot is rotatably received in the through hole.

6. The battery compartment according to claim 2, wherein the blocking groove is concaved from an inner surface of the cover facing to the main body, and the cover further comprises a bottom side, and a sidewall extending, the sidewall extends from an end of the bottom side and is away from the end of the cover extending the protrusion portion, the pushing rod supports the bottom side when the cover is rotated, the pushing rod abuts against the sidewall when the cover is opened.

7. The battery compartment according to claim 2, the concaved portion defines two opposite pivot holes, the two opposite ends are respectively inserted into the two opposite pivot holes.

8. The battery compartment according to claim 1, wherein the main body comprises a stepped portion accommodated with the cover.

9. The battery compartment according to claim 1, wherein the bracket is made of plastic materials.

10. The battery compartment according to claim 1, wherein the main body is mounted on the bracket via a screw.

11. An electronic cigarette, comprising:
an atomizer, and
a battery compartment, coupled to the atomizer, the battery compartment comprising:
a bracket;
a main body mounted to the bracket;
a cover rotatably mounted to the main body, the cover defining a blocking groove; and
an elastic pushing rod mounted on the bracket, the pushing rod being configured for inserting into the blocking groove to elastically support the cover when the cover is rotated.

12. The electronic cigarette according to claim 11, wherein an end of the cover extends to form a protrusion portion, the blocking groove is defined on the protrusion portion, the main body defines a concaved portion, the protrusion portion is accommodated in the concaved portion.

13. The electronic cigarette according to claim 12, further comprising a pivot, wherein the pivot enables the cover to rotatably mount to the main body, the pivot comprising two opposite ends, the pivot is rotatably inserted into the protrusion portion, the two opposite ends oppositely extend out of the protrusion portion and insert into the main body.

14. The electronic cigarette according to claim 13, wherein the pivot further comprises a main portion rotatably received in the protrusion portion, the two opposite ends extend from the main portion, a length of the main portion is larger than that of the through hole along an axis of the through hole.

15. The electronic cigarette to claim 12, wherein the protrusion portion further defines a through hole, the through hole is an oblong hole and the pivot is rotatably received in the through hole.

16. The electronic cigarette to claim 12, wherein the blocking groove is concaved from an inner surface of the cover facing to the main body, and the cover further comprises a bottom side, and a sidewall, the sidewall extends from an end of the bottom side and is away from the end of the cover extending the protrusion portion, the pushing rod supports the bottom side when the cover is rotated, the pushing rod abuts against the sidewall when the cover is opened.

17. The electronic cigarette according to claim 12, the concaved portion defines two opposite pivot holes, the two opposite ends are respectively inserted into the two opposite pivot holes.

18. A battery compartment, comprising:
a bracket;
a main body mounted to the bracket;
a cover rotatably mounted to the main body, the cover defining a blocking groove; and
an elastic pushing rod mounted on the bracket, the pushing rod being configured for elastically contacting to a position of the cover corresponding to the blocking groove, and an elastic force generated by the pushing rod being configured for exerting to the cover and resisting against the cover when the cover is opened.

19. The battery compartment according to claim 18, wherein an end of the cover extends to form a protrusion portion, the blocking groove is defined on the protrusion portion, the main body defines a concaved portion, and the protrusion portion is accommodated in the concaved portion.

20. The battery compartment according to claim 19, wherein the protrusion portion further defines a through hole, the through hole is an oblong hole and the pivot is rotatably received in the through hole.
